(19) United States
(12) Patent Application Publication
(10) Pub. No.: US 2024/0019539 A1
(43) Pub. Date: Jan. 18, 2024

(54) INFORMATION PROCESSING DEVICE, INFORMATION PROCESSING METHOD, AND INFORMATION PROCESSING SYSTEM

(71) Applicant: SONY GROUP CORPORATION, TOKYO (JP)

(72) Inventor: DAISUKE MATSUO, TOKYO (JP)

(21) Appl. No.: 18/247,102

(22) PCT Filed: Sep. 24, 2021
(86) PCT No.: PCT/JP2021/034940

§ 371 Date: Mar. 29, 2023

(30) Foreign Application Priority Data
Oct. 8, 2020 (JP) 2020-170239

(51) Int. Cl. G01S 7/35; G01S 7/493

(52) U.S. Cl. CPC G01S 7/354; G01S 7/493; B60W 60/00

(57) ABSTRACT

The present technology relates to an information processing device, an information processing method, and an information processing system which enable reduction in a capacity of a transmission path required for transmission of sensor data.

The information processing device extracts a part of sensor data of a distance measurement sensor to generate extracted data on the basis of a spectrum of a specific component of the sensor data. The present technology can be applied to a vehicle control system that performs processing related to vehicle travel assistance and automated driving.

### TECHNICAL FIELD

The present technology relates to an information processing device, an information processing method, and an information processing system, and more particularly, to an information processing device, an information processing method, and an information processing system which enable reduction in a capacity of a transmission path required for transmission of sensor data.

### BACKGROUND ART

In monitoring a situation around a mobile body, s technology for improving monitoring accuracy by mounting a plurality of sensors (radars) on the mobile body is proposed.

For example, Patent Document 1 proposes a technology for transmitting, aggregating, and fusing pieces of sensor data before signal processing of a plurality of sensors. Since pieces of the sensor data before signal processing are transmitted, aggregated, subjected to integration processing or the like, and then, used for detection, it is possible to expect object detection with high accuracy as compared with a case where detection results are transmitted and aggregated.

### CITATION LIST

### Patent Document

Patent Document 1: Japanese Patent Application Laid-Open No. 2018-42241

### SUMMARY OF THE INVENTION

### Problems to be Solved by the Invention

However, as compared with the case of transmitting the detection results, a higher transmission rate is required in order to transmit and aggregate pieces of the sensor data before signal processing, and for example, it is necessary to use a communication line having a large transmission capacity such as gigabit Ethernet.

In particular, it is not easy to provide such a communication line for each of the plurality of sensors mounted on the mobile body from the viewpoint of complexity of the configuration and cost.

The present technology has been made in view of such a situation, and an object thereof is to reduce a capacity of a transmission path required for transmission of sensor data.

### Solutions to Problems

An information processing device according to a first aspect of the present technology includes a signal extraction unit that extracts a part of sensor data of a distance measurement sensor to generate extracted data on the basis of a spectrum of a specific component of the sensor data.

An information processing system according to a second aspect of the present technology includes: a distance measurement sensor that extracts a part of sensor data to generate extracted data on the basis of a spectrum of a specific component of the sensor data; and a network that transmits the extracted data output from the distance measurement sensor.

In the first aspect of the present technology, the part of the sensor data of the distance measurement sensor is extracted to generate the extracted data on the basis of the spectrum of the specific component of the sensor data.

In the second aspect of the present technology, the distance measurement sensor extracts the part of the sensor data to generate the extracted data on the basis of the spectrum of the specific component of the sensor data, and the network transmits the extracted data output from the distance measurement sensor.

### BRIEF DESCRIPTION OF DRAWINGS

FIG. 1 is a block diagram illustrating a configuration example of a vehicle control system.

FIG. 2 is a diagram illustrating an example of a sensing region.

FIG. 3 is a block diagram illustrating a first configuration example of an object detection system to which the present technology is applied in the vehicle control system of FIG. 1.

FIG. 4 is a block diagram illustrating a configuration example of a radar.

FIG. 5 is a diagram illustrating an example of a transmission signal.

FIG. 6 is a block diagram illustrating a configuration example of a signal extraction unit.

FIG. 7 is a diagram illustrating an example of signal processing in the signal extraction unit.

FIG. 8 is a diagram illustrating a detailed example of a distance-velocity spectrum.

FIG. 9 is a flowchart for describing radar signal processing of the radar.

FIG. 10 is a flowchart illustrating signal extraction processing in step S105 of FIG. 9.

FIG. 11 is a block diagram illustrating a second configuration example of an object detection system to which the present technology is applied.

FIG. 12 is a block diagram illustrating a configuration example of the signal extraction unit.

FIG. 13 is a block diagram illustrating a third configuration example of an object detection system to which the present technology is applied.

FIG. 14 is a block diagram illustrating a fourth configuration example of an object detection system to which the present technology is applied.

FIG. 15 is a block diagram illustrating another configuration example of the signal extraction unit.

### MODE FOR CARRYING OUT THE INVENTION

Hereinafter, modes for carrying out the present technology will be described. A description will be given in the following order.
1. Configuration Example of Vehicle Control System
2. First Embodiment (Basic Configuration)
3. Second Embodiment (Sharing of Region Setting)
4. Third Embodiment (Multiple Different Sensors)
5. Fourth Embodiment (Region Setting Based on Another Sensor Data)
6. Fifth Embodiment (Transmission of Difference Signal)
7. Others

### 1. Configuration Example of Vehicle Control System

<Configuration of System>

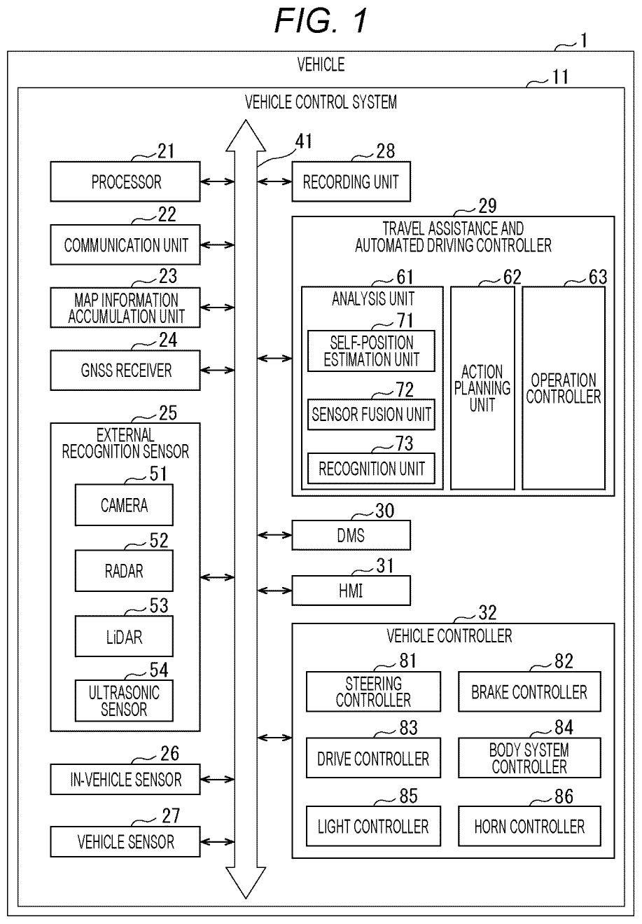

FIG. 1 is a block diagram illustrating a configuration example of a vehicle control system 11 which is an example of an object detection system to which the present technology is applied.

The vehicle control system 11 is provided in a vehicle 1, performs detection of an object outside the vehicle 1 and the like, and performs processes related to travel assistance and automated driving of the vehicle 1.

The vehicle control system 11 includes a vehicle control electronic control unit (ECU) 21, a communication unit 22, a map information accumulation unit 23, a global navigation satellite system (GNSS) receiver 24, an external recognition sensor 25, an in-vehicle sensor 26, a vehicle sensor 27, a recording unit 28, a travel assistance and automated driving controller 29, a driver monitoring system (DMS) 30, a human machine interface (HMI) 31, and a vehicle controller 32. Note that the vehicle control ECU 21 includes a processor and the like, and thus, is described as the processor in FIG. 1.

The vehicle control ECU 21, the communication unit 22, the map information accumulation unit 23, the GNSS receiver 24, the external recognition sensor 25, the in-vehicle sensor 26, the vehicle sensor 27, the recording unit 28, the travel assistance and automated driving controller 29, the DMS 30, the HMI 31, and the vehicle controller 32 are connected to be capable of communicating with each other via a communication network 41. The communication network 41 is configured using, for example, a vehicle-mounted communication network, a bus, or the like conforming to digital bidirectional communication standards such as a controller area network (CAN), a local interconnect network (LIN), a local area network (LAN), FlexRay (registered trademark), and Ethernet (registered trademark). The communication network 41 to be used may be selected according to types of data handled by the communication, and for example, the CAN is applied if data is related to vehicle control, and Ethernet is applied if data has a large volume. Note that there is also a case where the respective units of the vehicle control system 11 are directly connected to each other using wireless communication on an assumption of communication at a relatively near distance, such as near field communication (NFC) and Bluetooth (registered trademark) without using the communication network 41, for example.

Note that, hereinafter, the description of the communication network 41 will be omitted in a case where the respective units of the vehicle control system 11 perform communication via the communication network 41. For example, in a case where the vehicle control ECU 21 and the communication unit 22 perform communication via the communication network 41, it is simply described that the vehicle control ECU 21 and the communication unit 22 perform communication.

The vehicle control ECU 21 is configured using, for example, various processors such as a central processing unit (CPU) and a micro processing unit (MPU). The vehicle control ECU 21 controls all or some functions of the vehicle control system 11.

The communication unit 22 communicates with various devices inside and outside the vehicle, other vehicles, servers, base stations, and the like, and transmits and receives various types of data. At this time, the communication unit 22 can perform communication using a plurality of communication schemes.

An overview of the communication with the outside of the vehicle executable by the communication unit 22 will be described. For example, the communication unit 22 communicates with a server (hereinafter, referred to as an external server) or the like existing on an external network via a base station or an access point by a wireless communication scheme such as the 5th generation mobile communication system (5G), long term evolution (LTE), or dedicated short range communications (DSRC). The external network with which the communication unit 22 communicates is, for example, the Internet, a cloud network, a network unique to a business operator, or the like. A communication scheme by which the communication unit 22 communicates with the external network is not particularly limited as long as it is a wireless communication scheme capable of performing digital bidirectional communication at a communication speed equal to or higher than a predetermined speed and at a distance equal to or longer than a predetermined distance.

Furthermore, for example, the communication unit 22 can communicate with a terminal existing in the vicinity of the host vehicle using a peer to peer (P2P) technology. The terminal existing in the vicinity of the host vehicle is, for example, a terminal worn by a mobile body moving at a relatively low speed, such as a pedestrian or a bicycle, a terminal installed at a fixed position in a store or the like, or a machine type communication (MTC) terminal. Moreover, the communication unit 22 can also perform V2X communication. The V2X communication refers to, for example, communication between the host vehicle and others, such as vehicle to vehicle communication with another vehicle, vehicle to infrastructure communication with a roadside device or the like, vehicle to home communication, or vehicle to pedestrian communication with a terminal or the like carried by a pedestrian.

For example, the communication unit 22 can receive a program for updating software to control an operation of the vehicle control system 11 from the outside (Over The Air). The communication unit 22 can further receive map information, traffic information, information regarding surroundings of the vehicle 1, and the like from the outside. Furthermore, for example, the communication unit 22 can transmit information regarding the vehicle 1, information regarding surroundings of the vehicle 1, and the like to the outside. Examples of the information regarding the vehicle 1 transmitted to the outside by the communication unit 22 include data indicating a state of the vehicle 1, a recognition result obtained by a recognition unit 73, and the like. Moreover, for example, the communication unit 22 performs communication corresponding to a vehicle emergency call system such as eCall.

An overview of the communication with the inside of the vehicle executable by the communication unit 22 will be described. The communication unit 22 can communicate with each of devices inside the vehicle using, for example, wireless communication. The communication unit 22 can perform wireless communication with the devices inside the vehicle by a communication scheme capable of performing digital bidirectional communication at a predetermined communication speed or higher by wireless communication, such as wireless LAN, Bluetooth, NFC, or wireless USB (WUSB), for example. The communication unit 22 can also communicate with each of the devices inside the vehicle using wired communication without being limited thereto. For example, the communication unit 22 can communicate with each of the devices inside the vehicle by wired communication via a cable connected to a connection terminal (not illustrated). The communication unit 22 can communicate with each of the devices inside the vehicle by a communication scheme capable of performing digital bidirectional communication at a predetermined communication speed or higher by wired communication, such as a universal serial bus (USB), a high-definition multimedia interface (HDMI) (registered trademark), or a mobile high-definition link (MHL), for example.

Here, the devices inside the vehicle refer to, for example, devices that are not connected to the communication network 41 inside the vehicle. As the devices inside the vehicle, for example, a mobile device and a wearable device carried by a passenger such as a driver, an information device brought into the vehicle and temporarily installed, and the like are assumed.

For example, the communication unit 22 receives an electromagnetic wave transmitted by a vehicle information and communication system (VICS) (registered trademark) such as a radio wave beacon, an optical beacon, or FM multiplex broadcasting.

The map information accumulation unit 23 accumulates one or both of a map acquired from the outside and a map created by the vehicle 1. For example, the map information accumulation unit 23 accumulates a three-dimensional high-precision map, a global map that is less precise than the high-precision map and covers a wide area, and the like.

The high-precision map is, for example, a dynamic map, a point cloud map, a vector map, or the like. The dynamic map is, for example, a map including four layers of dynamic information, semi-dynamic information, semi-static information, and static information, and is provided to the vehicle 1 from an external server or the like. The point cloud map is a map including a point cloud (point cloud data). Here, it is assumed that the vector map refers to a map that is adapted to an advanced driver assistance system (ADAS) and includes traffic information, such as positions of lanes and traffic lights, associated with the point cloud map.

The point cloud map and the vector map may be provided from, for example, an external server or the like, or may be created in the vehicle 1 as a map for performing matching with a local map as described later on the basis of a sensing result obtained by the radar 52, the LiDAR 53, or the like, and may be accumulated in the map information accumulation unit 23. Furthermore, in a case where the high-precision map is provided from the external server or the like, for example, map data of several hundred meters around associated with a planned path on which the vehicle 1 is to travel from now is acquired from the external server or the like in order to reduce the communication volume.

The GNSS receiver 24 receives a GNSS signal from a GNSS satellite and acquires position information of the vehicle 1. The received GNSS signal is supplied to the travel assistance and automated driving controller 29. Note that the GNSS receiver 24 is not limited to a scheme using the GNSS signal, and may acquire the position information using, for example, a beacon.

The external recognition sensor 25 includes various sensors used for recognition of a situation outside the vehicle 1, and supplies sensor data from each of the sensors to each of the units of the vehicle control system 11. Types and number of the sensors included in the external recognition sensor 25 are freely set.

For example, the external recognition sensor 25 includes a camera 51, a radar 52, a light detection and ranging or laser imaging detection and ranging (LiDAR) 53, and an ultrasonic sensor 54. The external recognition sensor 25 may include one or more types of sensors selected from the camera 51, the radar 52, the LiDAR 53, and the ultrasonic sensor 54 without being limited thereto. The number of each of the camera 51, the radar 52, the LiDAR 53, and the ultrasonic sensor 54 is not particularly limited as long as the number is practically installable in the vehicle 1. Furthermore, the types of the sensors included in the external recognition sensor 25 are not limited to these examples, and the external recognition sensor 25 may include other types of sensors. Examples of sensing regions of the respective sensors included in the external recognition sensor 25 will be described later.

The radar 52 is, for example, a millimeter wave radar. The radar 52 includes a plurality of radars and is one of distance measurement sensors that detect an external object. The radar 52 transmits a transmission wave, receives a reflected wave from the object, and generates an extracted radar signal obtained by extracting a part of a radar signal on the basis of a spectrum of a specific component of a digital radar signal obtained by conversion. The specific component is, for example, at least one component such as a distance or a velocity. The radar 52 transmits the extracted radar signal thus generated as sensor data to, for example, the recognition unit 73 which is a unit that performs centralized processing for object detection. Therefore, a plurality of pieces of the sensor data is transmitted to the recognition unit 73.

Note that the processing described above is not limited to the radar 52, and may be performed by the LiDAR 53, the camera 51, or the like which is one of distance measurement sensors different from the radar 52, out of the external recognition sensor 25. For example, a plurality of pieces of sensor data from different types of distance measurement sensors, such as the radar 52 and the LiDAR 53, or sensor data and image data from the camera 51 are output. In this case, the plurality of pieces of sensor data or the sensor data and the image data are transmitted and received between the distance measurement sensors, for example, or are transmitted to a sensor fusion unit 72 and the recognition unit 73, for example, which are units that perform centralized processing for object detection.

The camera 51 may adopt any imaging scheme without particular limitation as long as the imaging scheme enables distance measurement. For example, as the camera 51, cameras of various imaging schemes, such as a time of flight (ToF) camera, a stereo camera, a monocular camera, and an infrared camera, can be applied as necessary. The camera 51 may be configured to simply acquire a captured image regardless of distance measurement without being limited thereto.

Furthermore, for example, the external recognition sensor 25 can include an environment sensor configured to detect an environment for the vehicle 1. The environment sensor is a sensor configured to detect an environment such as climate, weather, or brightness, and can include various sensors such as a raindrop sensor, a fog sensor, a sunlight sensor, a snow sensor, and an illuminance sensor, for example.

Moreover, for example, the external recognition sensor 25 includes a microphone used for detection of a sound around the vehicle 1 and a position of a sound source or the like.

The in-vehicle sensor 26 includes various sensors configured to detect information inside the vehicle, and supplies sensor data from each of the sensors to each of the units of the vehicle control system 11. Types and the number of the various sensors included in the in-vehicle sensor 26 are not particularly limited as long as the number can be practically installed in the vehicle 1.

For example, the in-vehicle sensor 26 can include one or more types of sensors selected from a camera, a radar, a seating sensor, a steering wheel sensor, a microphone, and a biometric sensor. As the camera included in the in-vehicle sensor 26, for example, cameras of various imaging schemes capable of distance measurement, such as a ToF camera, a stereo camera, a monocular camera, and an infrared camera, can be used. The camera included in the in-vehicle sensor 26 may be configured to simply acquire a captured image regardless of distance measurement without being limited thereto. The biometric sensor included in the in-vehicle sensor 26 is provided, for example, on a seat, a steering wheel, or the like, and detects various types of biometric information of a passenger such as a driver.

The vehicle sensor 27 includes various sensors configured to detect a state of the vehicle 1, and supplies sensor data from each of the sensors to each of the units of the vehicle control system 11. Types and the number of the various sensors included in the vehicle sensor 27 are not particularly limited as long as the number can be practically installed in the vehicle 1.

For example, the vehicle sensor 27 includes a velocity sensor, an acceleration sensor, an angular velocity sensor (gyro sensor), and an inertial measurement unit (IMU) in which these sensors are integrated. For example, the vehicle sensor 27 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 27 includes a rotation sensor that detects an engine speed or a motor speed, an air pressure sensor that detects an air pressure of a tire, a slip ratio sensor that detects a slip ratio of the tire, and a wheel speed sensor that detects a rotation speed of the wheel. For example, the vehicle sensor 27 includes a battery sensor that detects a remaining amount and a temperature of a battery, and an impact sensor that detects an impact from the outside.

The recording unit 28 includes at least one of a non-volatile storage medium or a volatile storage medium, and stores data and a program. The recording unit 28 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as the storage medium. The recording unit 28 records various programs and data used by the respective units of the vehicle control system 11. For example, the recording unit 28 includes an event data recorder (EDR) and a data storage system for automated driving (DSSAD), and records information of the vehicle 1 before and after an event such as an accident and biometric information acquired by the in-vehicle sensor 26.

The travel assistance and automated driving controller 29 controls travel assistance and automated driving of the vehicle 1. For example, the travel assistance and automated driving controller 29 includes an analysis unit 61, an action planning unit 62, and an operation controller 63.

The analysis unit 61 performs a process of analyzing situations of the vehicle 1 and the surroundings. The analysis unit 61 includes a self-position estimation unit 71, the sensor fusion unit 72, and the recognition unit 73.

The self-position estimation unit 71 estimates a self-position of the vehicle 1 on the basis of sensor data from the external recognition sensor 25 and the high-precision map accumulated in the map information accumulation unit 23. For example, the self-position estimation unit 71 generates a local map on the basis of the sensor data from the external recognition sensor 25, and performs matching between the local map and the high-precision map to estimate the self-position of the vehicle 1. The position of the vehicle 1 is defined, for example, on the basis of a center of a pair of axles of rear wheels.

The local map is, for example, a three-dimensional high-precision map, an occupancy grid map, or the like created using a technology such as simultaneous localization and mapping (SLAM). The three-dimensional high-precision map is, for example, the point cloud map or the like described above. The occupancy grid map is a map obtained by dividing a three-dimensional or two-dimensional space around the vehicle 1 into grids each having a predetermined size and indicating an occupancy state of an object in units of grids. The occupancy state of the object is indicated by, for example, presence or absence or a presence probability of the object. The local map is also used, for example, for detection processing and recognition processing of a situation outside the vehicle 1 performed by the recognition unit 73, for example.

Note that the self-position estimation unit 71 may estimate the self-position of the vehicle 1 on the basis of the GNSS signal and sensor data from the vehicle sensor 27.

The sensor fusion unit 72 performs sensor fusion processing of combining a plurality of different types of sensor data to obtain new information. Examples of the plurality of different types of sensor data include image data supplied from the camera 51, sensor data supplied from the radar 52, sensor data supplied from the LiDAR 53, and the like. Methods for combining the different types of sensor data include integration, fusion, unification, and the like. The sensor data combined by the sensor fusion unit 72 is output to the recognition unit 73.

The recognition unit 73 executes the detection processing of detecting the situation outside the vehicle 1 and the recognition processing of recognizing the situation outside the vehicle 1.

For example, the recognition unit 73 performs the detection processing and the recognition processing of the situation outside the vehicle 1 on the basis of information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The detection processing of the object is, for example, processing of detecting presence or absence, a size, a shape, a position, a motion, and the like of the object. The recognition processing of the object is, for example, processing of recognizing an attribute such as a type of the object or identifying a specific object. However, the detection processing and the recognition processing are not always clearly separated, but sometimes overlap.

Results of the detection processing and the recognition processing of the object are output to the vehicle controller 32 or the HMI 32 as described later. The results of the detection processing and the recognition processing of the object supplied from the recognition unit 73 are used for vehicle control in the vehicle controller 32 and the like, or used for presentation to a user by the HMI 31. For example, in a case where a collision with an object is predicted, it is possible to control a brake or a steering system or to present a warning to the user according to a distance to the object.

For example, the recognition unit 73 receives the extracted radar signal, which is sensor data from the radar 52, performs coordinate conversion of the extracted radar signal from each of the radars 52 into a rectangular coordinate system space common between the radars 52, and integrates signal distributions regarding all the radars 52 to perform object detection. The recognition unit 73 similarly performs object detection on sensor data received from the sensor fusion unit 72.

For example, the recognition unit 73 detects objects around the vehicle 1 by performing clustering to classify point clouds based on sensor data obtained by the radar 52, the LiDAR 53, and the like into blocks of point clouds. Therefore, presence or absence, a size, a shape, and a position of the object around the vehicle 1 are detected.

For example, the recognition unit 73 detects a motion of an object around the vehicle 1 by performing tracking to follow a motion of a block of a point cloud classified by clustering. Therefore, a velocity and a traveling direction (movement vector) of the object around the vehicle 1 are detected.

For example, the recognition unit 73 detects or recognizes a vehicle, a person, a bicycle, an obstacle, a structure, a road, a traffic light, a traffic sign, a road sign, and the like with respect to the image data supplied from the camera 51. Furthermore, a type of the object around the vehicle 1 may be recognized by performing recognition processing such as semantic segmentation.

For example, the recognition unit 73 can perform a process of recognizing a traffic rule around the vehicle 1 on the basis of a map accumulated in the map information accumulation unit 23, an estimation result of a self-position by the self-position estimation unit 71, and a recognition result of an object around the vehicle 1 obtained by the recognition unit 73. Through this process, the recognition unit 73 can recognize a position and a state of a signal, a content of a traffic sign and a road sign, a content of a traffic regulation, a travelable lane, and the like.

For example, the recognition unit 73 can perform a process of recognizing a surrounding environment of the vehicle 1. As the surrounding environment to be recognized by the recognition unit 73, climate, temperature, humidity, brightness, a state of a road surface, and the like are assumed.

The action planning unit 62 creates an action plan of the vehicle 1. For example, the action planning unit 62 creates the action plan by performing processes for path planning and path following.

Note that the path planning (global path planning) is a process of planning a rough path from a start to a goal. This path planning is called trajectory planning, and also includes a process of generating a trajectory (local path planning) that enables safe and smooth traveling in the vicinity of the vehicle 1 in consideration of movement characteristics of the vehicle 1 in a path planned by the path planning. The path planning may be distinguished from long-term path planning, and startup generation may be distinguished from short-term path planning or local path planning. A safety-first path represents a concept similar to startup generation, the short-term path planning, or the local path planning.

The path following is a process of planning an operation for safely and accurately traveling a path planned by the path planning within a planned time. For example, the action planning unit 62 can calculate a target velocity and a target angular velocity of the vehicle 1 on the basis of a result of the path following process.

The operation controller 63 controls the operation of the vehicle 1 in order to implement the action plan created by the action planning unit 62.

For example, the operation controller 63 controls a steering controller 81, a brake controller 82, and a drive controller 83 included in the vehicle controller 32 as described later, and performs acceleration/deceleration control and direction control such that the vehicle 1 travels on the trajectory calculated by the trajectory planning. For example, the operation controller 63 performs cooperative control for the purpose of implementing functions of the ADAS such as collision avoidance or impact mitigation, following traveling, vehicle speed maintaining traveling, collision warning to the host vehicle, and lane departure warning to the host vehicle. For example, the operation controller 63 performs cooperative control for the purpose of automated driving or the like for autonomous traveling without the driver's operation.

The DMS 30 performs a process of authenticating a driver, a process of recognizing a state of the driver, and the like on the basis of sensor data from the in-vehicle sensor 26, input data input to the HMI 31 as described later, and the like. As the state of the driver to be recognized by the DMS 30 in this case, for example, a physical condition, a wakefulness level, a concentration level, a fatigue level, a line-of-sight direction, a drunkenness level, a driving operation, a posture, and the like are assumed.

Note that the DMS 30 may perform a process of authenticating a passenger other than the driver and a process of recognizing a state of the passenger. Furthermore, for example, the DMS 30 may perform a process of recognizing of a situation inside the vehicle on the basis of sensor data from the in-vehicle sensor 26. As the situation inside the vehicle to be recognized, for example, temperature, humidity, brightness, a smell, and the like are assumed.

The HMI 31 inputs various types of data, instructions, and the like, and presents various types of data to the driver or the like.

An overview of the input of data performed by the HMI 31 will be described. The HMI 31 includes an input device configured to allow a person to input data. The HMI 31 generates an input signal on the basis of data, an instruction, or the like input through the input device, and supplies the input signal to the respective units of the vehicle control system 11. The HMI 31 includes, for example, an operating element such as a touch panel, a button, a switch, or a lever as the input device. The HMI 31 is not limited thereto, and may further include an input device through which information can be input by a method other than manual operation using voice, a gesture, or the like. Moreover, the HMI 31 may use, for example, a remote control device using infrared rays or radio waves, or an external connection device such as a mobile device or a wearable device handling operations of the vehicle control system 11 as the input device.

An overview of the presentation of data performed by the HMI 31 will be described. The HMI 31 generates visual information, auditory information, and haptic information for a passenger or the outside of the vehicle. Furthermore, the HMI 31 performs output control for controlling output, an output content, an output timing, an output method, and the like of each piece of the generated information. The HMI 31 generates and outputs, as the visual information indicated by an image or light, for example, an operation screen, a state display of the vehicle 1, a warning display, a monitor image indicating a situation around the vehicle 1, or the like. Furthermore, the HMI 31 generates and outputs, as the auditory information, information indicated by sounds, for example, voice guidance, a warning sound, a warning message, or the like. Moreover, the HMI 31 generates and outputs, as the haptic information, information given to the haptic sense of the passenger by, for example, a force, a vibration, a motion, or the like.

As an output device through which the HMI 31 outputs the visual information, for example, a display device that presents the visual information by displaying an image by itself or a projector device that presents the visual information by projecting an image can be applied. Note that the display device may be a device that displays the visual information in the field of view of the passenger, such as a head-up display, a transmissive display, or a wearable device having an augmented reality (AR) function, for example, in addition to a display device having a normal display. Furthermore, in the HMI 31, a display device included in a navigation device, an instrument panel, a camera monitoring system (CMS), an electronic mirror, a lamp, or the like provided in the vehicle 1 can also be used as the output device configured to output the visual information.

As an output device through which the HMI 31 outputs the auditory information, for example, an audio speaker, a headphone, or an earphone can be applied.

As an output device through which the HMI 31 outputs the haptic information, for example, a haptic element using a haptic technology can be applied. The haptic element is provided, for example, at a portion with which the passenger of the vehicle 1 comes into contact, such as a steering wheel or a seat.

The vehicle controller 32 controls the respective units of the vehicle 1. The vehicle controller 32 includes the steering controller 81, the brake controller 82, the drive controller 83, a body system controller 84, a light controller 85, and a horn controller 86.

The steering controller 81, for example, detects and controls a state of a steering system of the vehicle 1. The steering system includes, for example, a steering mechanism including a steering wheel and the like, an electric power steering, and the like. The steering controller 81 includes, for example, a control unit such as an ECU that controls the steering system, an actuator that drives the steering system, and the like.

The brake controller 82, for example, detects and controls a state of a brake system of the vehicle 1. The brake system includes, for example, a brake mechanism including a brake pedal and the like, an antilock brake system (ABS), a regenerative brake mechanism, and the like. The brake controller 82 includes, for example, a control unit, such as an ECU that controls the brake system, and the like.

The drive controller 83, for example, detects and controls a state of a drive system of the vehicle 1. The drive system includes, for example, a driving force generation device configured to generate a driving force such as an accelerator pedal, an internal combustion engine, or a driving motor, a driving force transmission mechanism configured to transmit the driving force to wheels, and the like. The drive controller 83 includes, for example, a control unit, such as an ECU that controls the drive system, and the like.

The body system controller 84, for example, detects and controls a state of a body system of the vehicle 1. The body system includes, for example, a keyless entry system, a smart key system, a power window device, a power seat, an air conditioner, an airbag, a seat belt, a shift lever, and the like. The body system controller 84 includes, for example, a control unit, such as an ECU that controls the body system, and the like.

The light controller 85, for example, detects and controls states of various lights of the vehicle 1. As the lights to be controlled, for example, a headlight, a backlight, a fog light, a turn signal, a brake light, a projection, a display of a bumper, and the like are assumed. The light controller 85 includes a control unit, such as an ECU that controls the lights, and the like.

The horn controller 86, for example, detects and controls a state of a car horn of the vehicle 1. The horn controller 86 includes, for example, a control unit such as an ECU that controls the car horn and the like.

<Sensing Region>

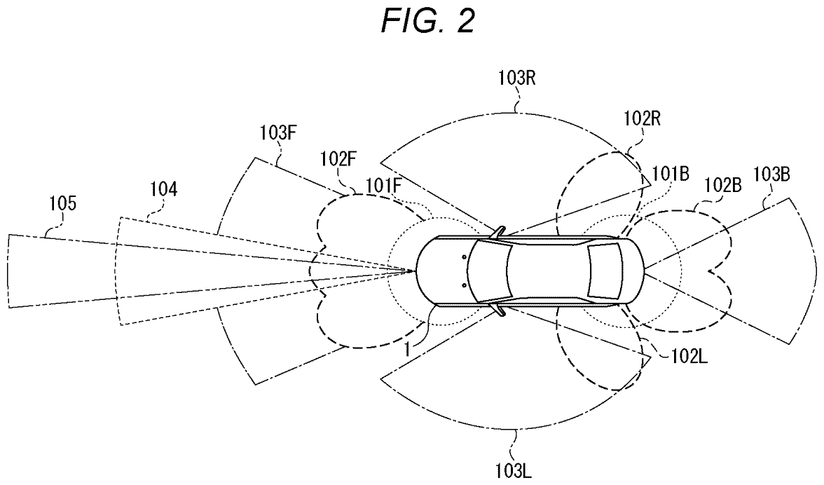

FIG. 2 is a diagram illustrating examples of sensing regions obtained by the camera 51, the radar 52, the LiDAR 53, the ultrasonic sensor 54, and the like of the external recognition sensor 25 in FIG. 1. Note that FIG. 2 schematically illustrates an appearance of the vehicle 1 as viewed from above, in which the left end side corresponds to the front end (front) side of the vehicle 1 and the right end side corresponds to the rear end (rear) side of the vehicle 1.

A sensing region 101F and a sensing region 101B illustrate examples of the sensing region of the ultrasonic sensor 54. The sensing region 101F covers a periphery of the front end of the vehicle 1 by a plurality of the ultrasonic sensors 54. The sensing region 101B covers a periphery of the rear end of the vehicle 1 by a plurality of the ultrasonic sensors 54.

Sensing results in the sensing region 101F and the sensing region 101B are used, for example, to assist parking of the vehicle 1 or the like.

Sensing regions 102F to 102B illustrate examples of the sensing region of the radar 52 for a short range or a middle range. The sensing region 102F covers the front of the vehicle 1 up to a position farther than that of the sensing region 101F. The sensing region 102B covers the rear of the vehicle 1 up to a position farther than that of the sensing region 101B. The sensing region 102L covers a rear periphery of a left side surface of the vehicle 1. The sensing region 102R covers a rear periphery of a right side surface of the vehicle 1.

A sensing result in the sensing region 102F is used, for example, to detect a vehicle, a pedestrian, or the like existing in front of the vehicle 1 or the like. A sensing result in the sensing region 102B is used, for example, for a function of preventing a collision at the rear of the vehicle 1, and the like. Sensing results in the sensing region 102L and the sensing region 102R are used, for example, to detect an object at a blind spot on the side of the vehicle 1.

Sensing regions 103F to 103B illustrate examples of the sensing region of the camera 51. The sensing region 103F covers the front of the vehicle 1 up to a position farther than that of the sensing region 102F. The sensing region 103B covers the rear of the vehicle 1 up to a position farther than that of the sensing region 102B. The sensing region 103L covers a periphery of the left side surface of the vehicle 1. The sensing region 103R covers a periphery of the right side surface of the vehicle 1.

A sensing result in the sensing region 103F can be used, for example, for recognition of a traffic light and a traffic sign, a lane departure prevention assist system, and an automatic headlight control system. A sensing result in the sensing region 103B can be used, for example, for parking assistance and a surround-view system. Sensing results in the sensing region 103L and the sensing region 103R can be used, for example, for a surround-view system.

A sensing region 104 illustrates an example of the sensing region of the LiDAR 53. The sensing region 104 covers the front of the vehicle 1 up to a position farther than that of the sensing region 103F. On the other hand, the sensing region 104 has a narrower range in the left-right direction than that of the sensing region 103F.

A sensing result in the sensing region 104 is used, for example, to detect an object such as a surrounding vehicle.

A sensing region 105 illustrates an example of the sensing region of the radar 52 for a long range. The sensing region 105 covers the front of the vehicle 1 up to a position farther than that of the sensing region 104. On the other hand, the sensing region 105 has a narrower range in the left-right direction than that of the sensing region 104.

A sensing result in the sensing region 105 is used, for example, for adaptive cruise control (ACC), emergency braking, collision avoidance, and the like.

Note that the sensing regions of the respective sensors of the camera 51, the radar 52, the LiDAR 53, and the ultrasonic sensor 54 included in the external recognition sensor 25 may have various configurations other than those in FIG. 2. Specifically, the ultrasonic sensor 54 may also sense the side of the vehicle 1, or the LiDAR 53 may sense the rear of the vehicle 1. Furthermore, an installation position of each of the sensors is not limited to each example described above. Furthermore, the number of each of the sensors may be one or two or more.

### 2. First Embodiment (Basic Configuration)

<First Configuration of Object Detection System>

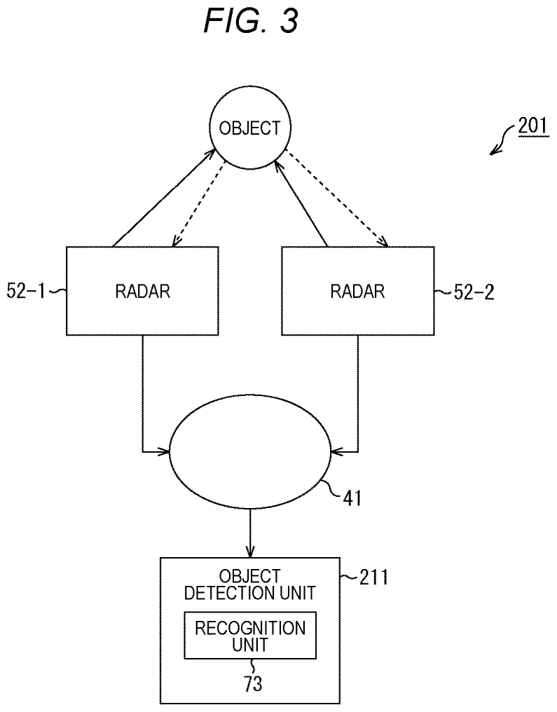

FIG. 3 is a block diagram illustrating a first configuration example of an object detection system to which the present technology is applied in the vehicle control system of FIG. 1.

An object detection system 201 in FIG. 3 includes a radar 52-1, a radar 52-2, the communication network 41, and an object detection unit 211. Note that, in a case where it is unnecessary to distinguish the radar 52-1 and the radar 52-2, the both are referred to as the radars 52. Although the two radars 52 are illustrated, it suffices that a plurality of radars is used, and the number of radars is not limited to two.

In FIG. 3, solid arrows directed toward an object represent transmission waves, and broken arrows exiting from the object represent reflected waves.

As described above in FIG. 1, the radar 52 transmits the transmission wave, receives the reflected wave from the object, and generates an extracted radar signal obtained by extracting a part of a radar signal on the basis of a spectrum of a specific component of a digital radar signal obtained by conversion. The radar 52 transmits the extracted radar signal thus generated as sensor data to the object detection unit 211 via the communication network 41.

The object detection unit 211 includes at least the recognition unit 73 in FIG. 1, for example. The recognition unit 73 receives the sensor data transmitted from the plurality of radars 52. The recognition unit 73 performs object detection processing using the received sensor data. Although not illustrated in FIG. 3, the recognition unit 73 performs object detection processing on the basis of information from the self-position estimation unit 71 as well if necessary. That is, the object detection unit 211 may include the analysis unit 61.

Note that the example in which the sensor data is transmitted from the radar 52 to the object detection unit 211 has been described in FIG. 3, but the sensor data may be transmitted from the radar 52 to the object detection unit 211 via the vehicle control ECU 21.

<Configuration Example of Radar>

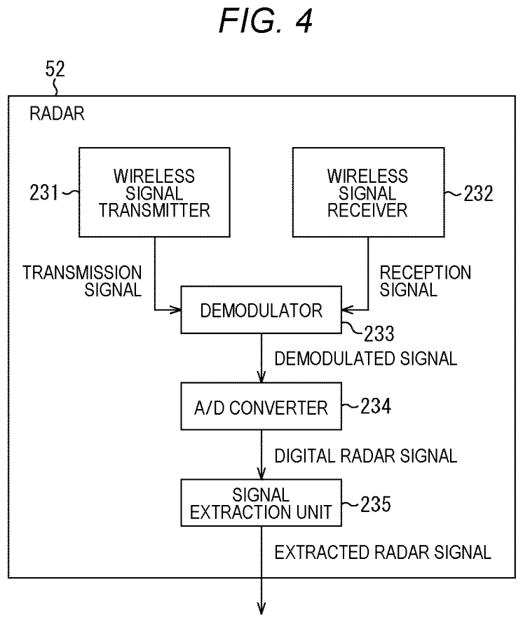

FIG. 4 is a block diagram illustrating a configuration example of the radar.

The radar 52 includes a wireless signal transmitter 231, a wireless signal receiver 232, a demodulator 233, an analog/digital (A/D) converter 234, and a signal extraction unit 235.

The wireless signal transmitter 231 generates a transmission signal. For example, in a case where the radar 52 is a radar of a fast-chirp modulation (FCM) scheme, the wireless signal transmitter 231 generates a transmission signal that repeats a chirp signal whose frequency linearly changes at a high speed as a transmission wave to be emitted into space.

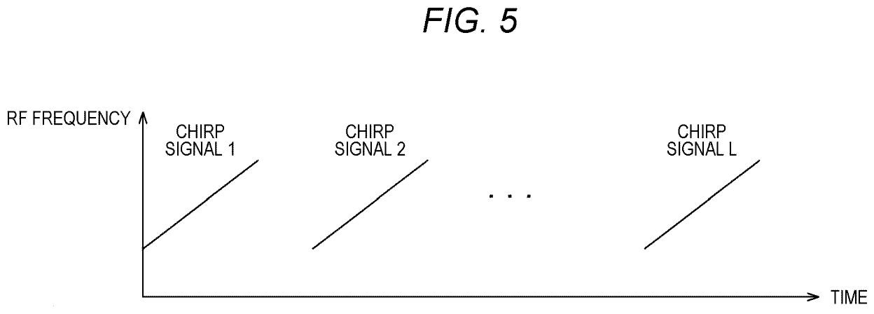

FIG. 5 is a diagram illustrating an example of the transmission signal.

FIG. 5 illustrates an example in which the transmission signal includes a chirp signal 1 to a chirp signal L with the vertical axis representing an RF frequency and the horizontal axis representing time. As illustrated in FIG. 5, each of the chirp signals is a signal whose RF frequency changes linearly. Furthermore, each of the chirp signals is started at a high speed such that an interval with an immediately previous chirp signal is shorter than a time length of each of the chirp signals.

Returning to FIG. 4, the wireless signal transmitter 231 emits the transmission signal as the transmission wave into space using a single antenna or a plurality of antennas. Furthermore, the wireless signal transmitter 231 outputs the transmission signal to the demodulator 233.

The transmission wave emitted into space is reflected by an object to become a reflected wave.

The wireless signal receiver 232 receives the reflected wave using a single antenna or a plurality of antennas, and outputs the reflected wave as a reception signal to the demodulator 233.

The demodulator 233 demodulates a radar signal on the basis of the transmission signal supplied from the wireless signal transmitter 231 and the reception signal supplied from the wireless signal receiver 232, and generates a demodulated radar signal (demodulated signal). The radar signal includes position information and velocity information of the object.

In the case where the radar 52 is the radar of the fast-chirp modulation (FCM) scheme, the demodulator 233 mixes the reception signal and the transmission signal to generate the radar signal including a difference frequency between the transmission signal and the reception signal. The frequency of the radar signal is proportional to a distance between the object and the radar 52. The amount of phase change between the repeated chirp signals is proportional to a relative velocity between the object and the radar 52.

The demodulator 233 outputs the generated demodulated signal to the A/D converter 234.

The A/D converter 234 samples and quantizes the demodulated signal supplied from the demodulator 233 for conversion into a digital value, and generates a digital radar signal.

Note that a transmission signal and a reception signal may be converted into digital signals in advance in the A/D converter 234, and then, a digital radar signal may be generated in the demodulator 233 according to a radar scheme.

The improvement in detection accuracy can be expected when the digital radar signals from the plurality of radars 52 are aggregated and subjected to detection processing. However, it is necessary to use a communication line having a large transmission capacity such as Gigabit Ethernet in order to transmit the plurality of digital radar signals without delay.

Therefore, in the present technology, the signal extraction unit 235 extracts a part of the digital radar signal to reduce the amount of data.

The signal extraction unit 235 generates an extracted radar signal obtained by extracting the part of the radar signal on the basis of a spectrum of a specific component of the digital radar signal supplied from the A/D converter 234. The signal extraction unit 235 transmits the extracted radar signal to the object detection unit 211 as sensor data.

<Configuration of Signal Extraction Unit>

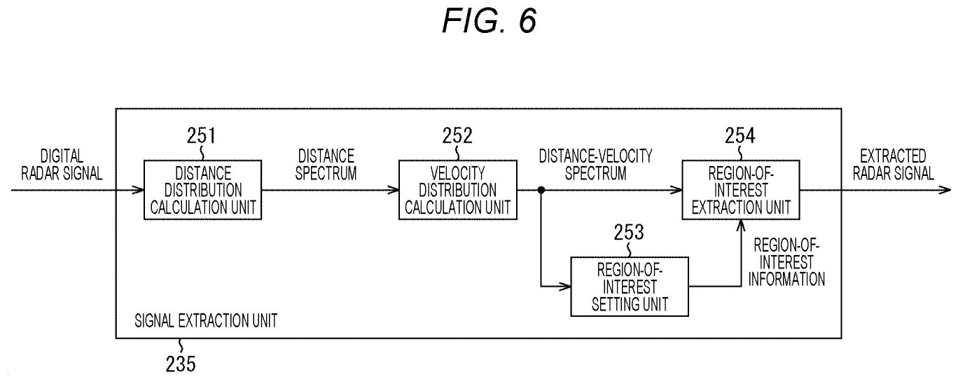

FIG. 6 is a block diagram illustrating a configuration example of the signal extraction unit 235.

In FIG. 6, the signal extraction unit 235 includes a distance distribution calculation unit 251, a velocity distribution calculation unit 252, a region-of-interest setting unit 253, and a region-of-interest extraction unit 254.

The distance distribution calculation unit 251 converts a digital radar signal supplied from the A/D converter 234 into a distance spectrum that is a one-dimensional spectrum. The distance distribution calculation unit 251 outputs the converted distance spectrum to the velocity distribution calculation unit 252.

The velocity distribution calculation unit 252 calculates a distance-velocity spectrum that is a two-dimensional spectrum from the distance spectrum supplied by the distance distribution calculation unit 251. The velocity distribution calculation unit 252 outputs the calculated distance-velocity spectrum to the region-of-interest setting unit 253 and the region-of-interest extraction unit 254.

The region-of-interest setting unit 253 sets a region of interest on the basis of the distance-velocity spectrum supplied from the velocity distribution calculation unit 252. The region-of-interest setting unit 253 outputs region-of-interest information indicating the set region of interest to the region-of-interest extraction unit 254.

The region-of-interest extraction unit 254 extracts components included in the region of interest set by the region-of-interest setting unit 253 from the distance-velocity spectrum supplied from the velocity distribution calculation unit 252, and generates an extracted radar signal. The region-of-interest extraction unit 254 transmits the extracted radar signal thus generated to the object detection unit 211.

<Signal Processing>

Next, for example, signal processing in the case where the radar 52 is the radar of the FCM scheme will be specifically described.

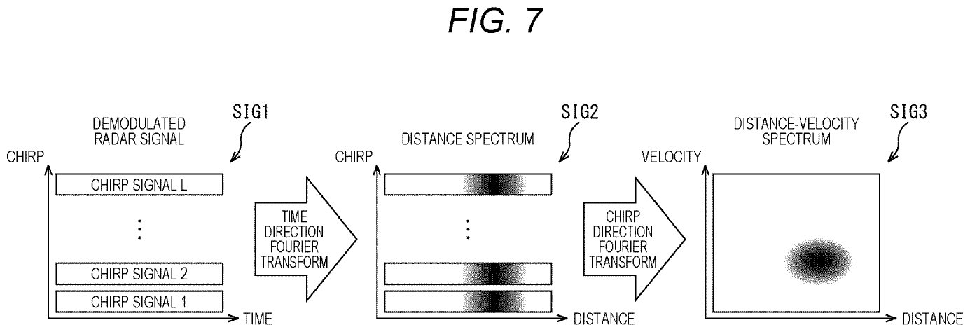

FIG. 7 is a diagram illustrating an example of the signal processing in the signal extraction unit 235.

In FIG. 7, a demodulated radar signal SIG1, a distance spectrum SIG2, and a distance-velocity spectrum SIG3 are schematically illustrated from the left.

The demodulated radar signal SIG1 is a signal demodulated by the demodulator 233 and converted by the A/D converter 234, and is supplied to the distance distribution calculation unit 251.

In the demodulated radar signal SIG1 of FIG. 7, the vertical axis represents chirp signals in a transmission timing order, and the horizontal axis represents time. The demodulated radar signal SIG1 includes a chirp signal 1 to a chirp signal L.

Since a frequency of the radar signal SIG1 is proportional to a distance between an object and the radar 52, the distance distribution calculation unit 251 obtains the distance spectrum SIG2 by performing Fourier transform with respect to samples in the respective chirp signals (time).

The distance spectrum SIG2 is a signal calculated by the distance distribution calculation unit 251, and is supplied to the velocity distribution calculation unit 252.

In the distance spectrum SIG2 of FIG. 7, the vertical axis represents the chirp signals in the transmission timing order, and the horizontal axis represents the distance. In the distance spectrum SIG2, denseness of density represents the magnitude of power. In the respective chirp signal, since the power in a periphery at a distance where the object is located is high, the density in the periphery is densely expressed in the distance spectrum SIG2.

The velocity distribution calculation unit 252 arranges distance spectra of the chirp signals in a chirp transmission timing order, and performs Fourier transform with respect to a chirp transmission timing direction. Therefore, a velocity is calculated from the phase change between the respective chirps, and a velocity spectrum for each distance, that is, the distance-velocity spectrum SIG3 is obtained.

The distance-velocity spectrum SIG3 is a signal calculated by the velocity distribution calculation unit 252, and is supplied to the region-of-interest setting unit 253 and the region-of-interest extraction unit 254.

In the distance-velocity spectrum SIG3 of FIG. 7, the vertical axis represents the velocity and the horizontal axis represents the distance. In the distance-velocity spectrum SIG3, denseness of density represents the magnitude of power. Since the power in a periphery at a distance and a velocity corresponding to the distance and the velocity of the object is high, the density in the periphery is densely expressed in the distance-velocity spectrum SIG3.

<Distance-Velocity Spectrum>

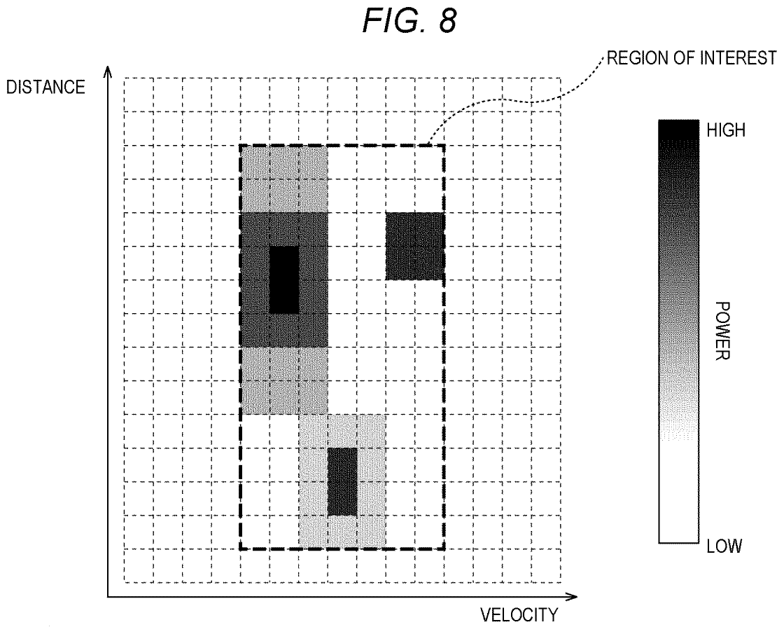

FIG. 8 is a diagram illustrating a detailed example of the distance-velocity spectrum.

In the distance-velocity spectrum in FIG. 8, the vertical axis represents the distance, and the horizontal axis represents the velocity. In FIG. 8, each square is a bin indicating a distance-velocity range. A higher-density bin represents higher power and a lower-density bin represents lower power.

The spectral components of the distance-velocity spectrum are concentrated in bins in a distance-velocity range corresponding to the distance and the velocity of the object as indicated by the density. Therefore, it is considered that the influence on the object detection accuracy is small even if information of a bin having a low density, that is, a few spectral components is cut off.

Therefore, the region-of-interest setting unit 253 sets a region where the spectral components are concentrated in the distance-velocity spectrum as the region of interest. For example, the region-of-interest setting unit 253 sets a distance range and a velocity range (a range surrounded by a broken line in FIG. 8) including a bin in which an intensity of the spectral component is equal to or more than a predetermined threshold as the region of interest.

The region-of-interest information indicating the set region of interest is output to the region-of-interest extraction unit 254.

The region-of-interest extraction unit 254 extracts the spectral components (complex signals) present in the bins within the range indicated by the region-of-interest information from the distance-velocity spectrum supplied from the velocity distribution calculation unit 252 on the basis of the region-of-interest information supplied from the region-of-interest setting unit 253, and generates an extracted radar signal.

<Processing of Radar>

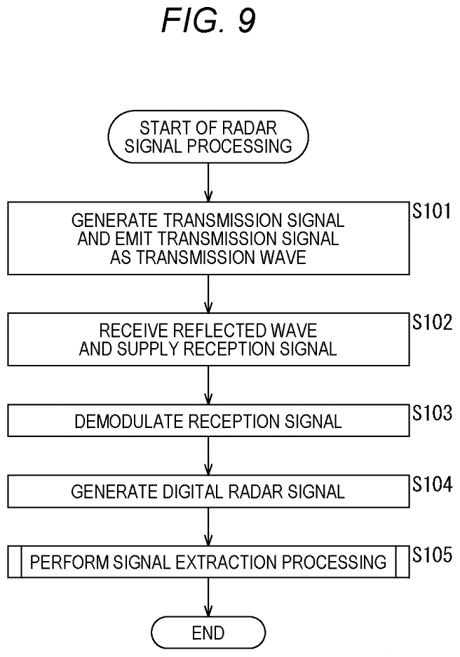

FIG. 9 is a flowchart for describing radar signal processing of the radar 52.

In step S101, the wireless signal transmitter 231 generates a transmission signal and emits the transmission signal as a transmission wave into space using a single antenna or a plurality of antennas.

The transmission wave emitted into space is reflected by an object to become a reflected wave.

In step S102, the wireless signal receiver 232 receives the reflected wave using a single antenna or a plurality of antennas, and outputs the reflected wave as a reception signal to the demodulator 233.

In step S103, the demodulator 233 demodulates a radar signal on the basis of the transmission signal supplied from the wireless signal transmitter 231 and the reception signal supplied from the wireless signal receiver 232, and generates a demodulated radar signal. The demodulator 233 outputs the generated demodulated signal to the A/D converter 234.

In step S104, the A/D converter 234 samples and quantizes the demodulated signal supplied from the demodulator 233 for conversion into a digital value, and generates a digital radar signal.

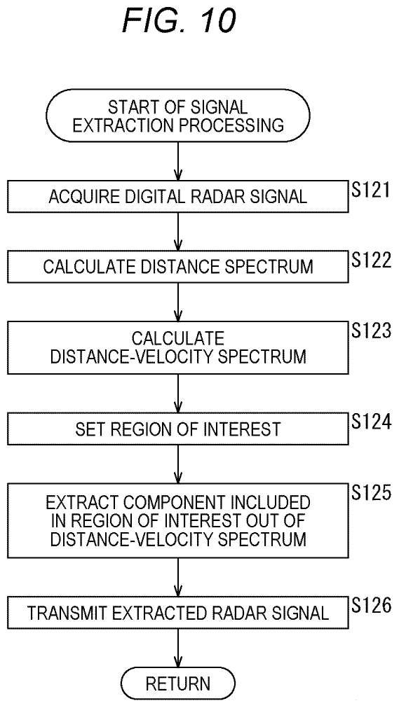

In step S105, the signal extraction unit 235 performs signal extraction processing. Details of the signal extraction processing will be described later with reference to FIG. 10. Through the processing in step S105, an extracted radar signal obtained by extracting a part of the radar signal is generated on the basis of a spectrum of a specific component of the digital radar signal supplied from the A/D converter 234, and is transmitted to the object detection unit 211.

<Signal Extraction Processing>

FIG. 10 is a flowchart illustrating the signal extraction processing in step S105 of FIG. 9.

In step S121, the distance distribution calculation unit 251 acquires the digital radar signal supplied from the A/D converter 234.

In step S122, the distance distribution calculation unit 251 converts the acquired digital radar signal into a distance spectrum. The distance distribution calculation unit 251 outputs the converted distance spectrum to the velocity distribution calculation unit 252.

In step S123, a distance-velocity spectrum is calculated from the distance spectrum supplied by the distance distribution calculation unit 251. The velocity distribution calculation unit 252 outputs the calculated distance-velocity spectrum to the region-of-interest setting unit 253 and the region-of-interest extraction unit 254.

In step S124, the region-of-interest setting unit 253 sets a region of interest on the basis of the distance-velocity spectrum supplied from the velocity distribution calculation unit 252. The region-of-interest setting unit 253 outputs region-of-interest information indicating the set region of interest to the region-of-interest extraction unit 254.

In step S125, the region-of-interest extraction unit 254 extracts a component included in the region of interest indicated by the region-of-interest information from the distance-velocity spectrum supplied from the velocity distribution calculation unit 252, and generates an extracted radar signal.

In step S126, the region-of-interest extraction unit 254 transmits the generated extracted radar signal as sensor data to the object detection unit 211 via the communication network 41.

As described above, the sensor data is transmitted to the object detection unit 211 by the radar 52.

The recognition unit 73 of the object detection unit 211 receives the extracted radar signal that is the sensor data, and executes object detection processing. For example, the recognition unit 73 performs coordinate conversion of the extracted radar signal of each of the radars 52 into an orthogonal coordinate system space common among the radars 52, and integrates signal distributions regarding all the radars 52, thereby enhancing the accuracy of object detection.

Note that information of a bin in which the possibility that an object exists is low is cut off in the signal extraction unit 235 as described above, and thus, the accuracy of object detection is hardly affected by signal extraction.

As described above, it is possible to reduce the transmission capacity required for the communication line used for transmission of the sensor data while maintaining the accuracy of object detection in the object detection using the plurality of radars 52 according to the first embodiment of the present technology.

Note that the extracted radar signal is generated on the basis of the distance-velocity spectrum as the spectrum of the specific component in the description described above, but an extracted radar signal may be generated on the basis of the distance spectrum or the velocity spectrum instead of the distance-velocity spectrum.

Furthermore, in a case where the wireless signal transmitter 231 and the wireless signal receiver 232 have a beam scanning function and an antenna array, and can acquire an angle spectrum that is a distribution of angles at which an object exists, an extracted radar signal may be generated on the basis of the angle spectrum. For example, an extracted radar signal may be generated on the basis of an angle-distance spectrum, an angle-velocity spectrum, or an angle-distance-velocity spectrum.

A region of interest may be determined in advance in a specific range before transmission and reception of a radar. When a range in which object detection is desired to be performed with a higher accuracy using a plurality of radars is determined in advance, it is possible to aggregate signals of the plurality of radars regarding the determined region of interest.

### 3. Second Embodiment (Sharing of Region Setting)

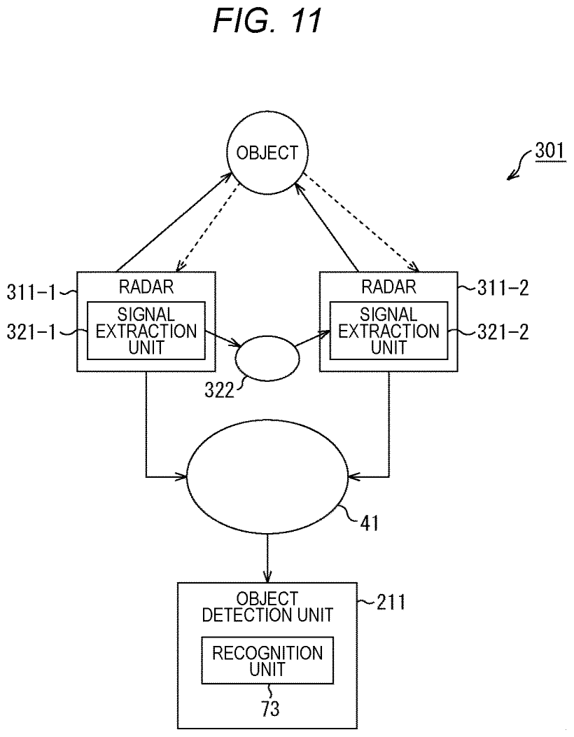

A region of interest may be set by one radar among a plurality of radars, and information regarding the set region-of-interest information may be shared with the other radars such that the respective radars set the region of interest on the basis of the shared region-of-interest information from the viewpoint of consistency of the region of interest in the respective radars at the time of aggregation. In this case, an object detection system can be configured as illustrated in FIG. 11.

<Second Configuration of Object Detection System>

FIG. 11 is a block diagram illustrating a second configuration example of an object detection system to which the present technology is applied in the vehicle control system of FIG. 1.

An object detection system 301 in FIG. 11 includes a radar 311-1, a radar 311-2, the communication network 41, a network 322, and the object detection unit 211. Note that, in FIG. 11, portions corresponding to those in FIG. 3 are denoted by corresponding reference signs, and the description thereof is repeated, and thus, will be omitted

The radar 311-1 is different only in that the signal extraction unit 235 is replaced with a signal extraction unit 321-1, and has the other configurations common to those of the radar 52-1. The radar 311-2 is different only in that the signal extraction unit 235 is replaced with a signal extraction unit 321-2, and has the other configurations common to those of the radar 52-2.

That is, the signal extraction unit 321-1 generates an extracted radar signal obtained by extracting a part of a radar signal on the basis of a spectrum of a specific component of a digital radar signal obtained as a reflected wave from an object. At that time, the signal extraction unit 321-1 sets a region of interest on the basis of a distance-velocity spectrum obtained from the digital radar signal, and transmits region-of-interest information to the signal extraction unit 321-2 via the network 322. Furthermore, the signal extraction unit 321-1 generates an extracted radar signal on the basis of the set region of interest, and transmits the extracted radar signal as sensor data to the object detection unit 211.

The signal extraction unit 321-2 extracts the specific component from the digital radar signal obtained as the reflected wave from the object, and generates the extracted radar signal. At that time, the signal extraction unit 321-2 generates the extracted radar signal on the basis of the region of interest indicated by the region-of-interest information received via the network 322, and transmits the extracted radar signal as sensor data to the object detection unit 211.

Note that, in a case where it is unnecessary to distinguish the radar 311-1 and the radar 311-2, the both are referred to as the radars 311. In a case where it is unnecessary to distinguish the signal extraction unit 321-1 and the signal extraction unit 321-2, the both are referred to as the signal extraction units 321.

The network 322 is a network different from the communication network 41. However, the network 322 may be the same network as the communication network 41.

Furthermore, the signal extraction unit 321-1 and the signal extraction unit 321-2 may be directly connected without the network 322, for example, as in a case where the radars 311-1 and 311-2 are provided in the same housing or the like.

<Signal Extraction Unit>

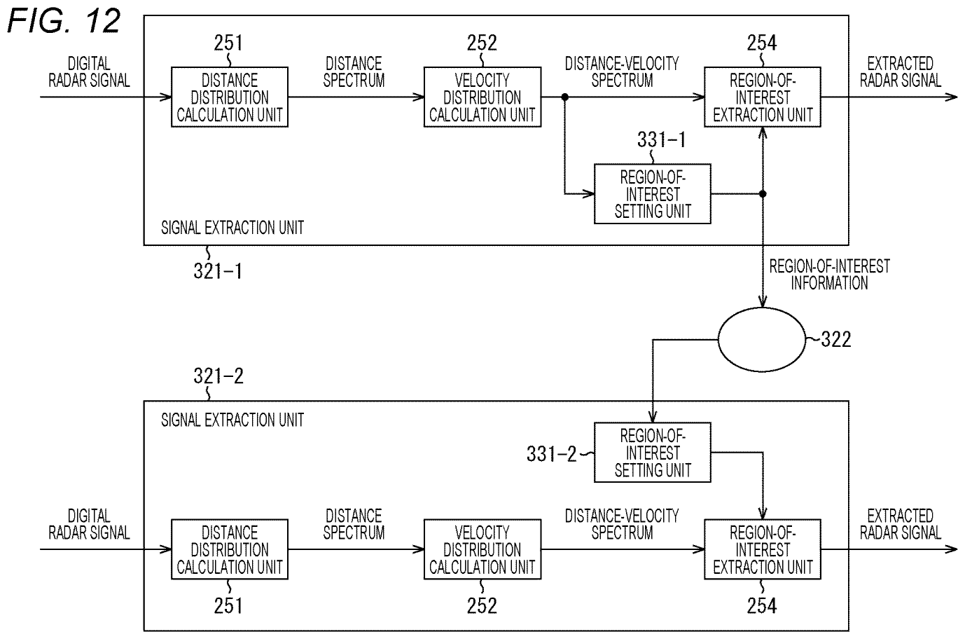

FIG. 12 is a block diagram illustrating configuration examples of the signal extraction unit 321-1 and the signal extraction unit 321-2.

Note that, in FIG. 12, portions corresponding to those in FIG. 6 are denoted by corresponding reference signs, and the description thereof is repeated, and thus, will be omitted

The signal extraction unit 321-1 includes the distance distribution calculation unit 251, the velocity distribution calculation unit 252, a region-of-interest setting unit 331-1, and the region-of-interest extraction unit 254.

The region-of-interest setting unit 331-1 sets a region of interest on the basis of a distance-velocity spectrum supplied from the velocity distribution calculation unit 252. The region-of-interest setting unit 331-1 outputs region-of-interest information indicating the set region of interest to the region-of-interest setting unit 331-2 of the signal extraction unit 321-2 via the region-of-interest extraction unit 254 and the network 322.

The signal extraction unit 321-2 includes the distance distribution calculation unit 251, the velocity distribution calculation unit 252, a region-of-interest setting unit 331-2, and the region-of-interest extraction unit 254.

The region-of-interest setting unit 331-2 sets a region of interest on the basis of the region-of-interest information set by the region-of-interest setting unit 331-2 of the signal extraction unit 321-2.

With the above configuration, it is possible to maintain consistency of the region of interest in the respective radars at the time of aggregation in the object detection unit 211.

### 4. Third Embodiment (Multiple Different Sensors)

<Third Configuration of Object Detection System>

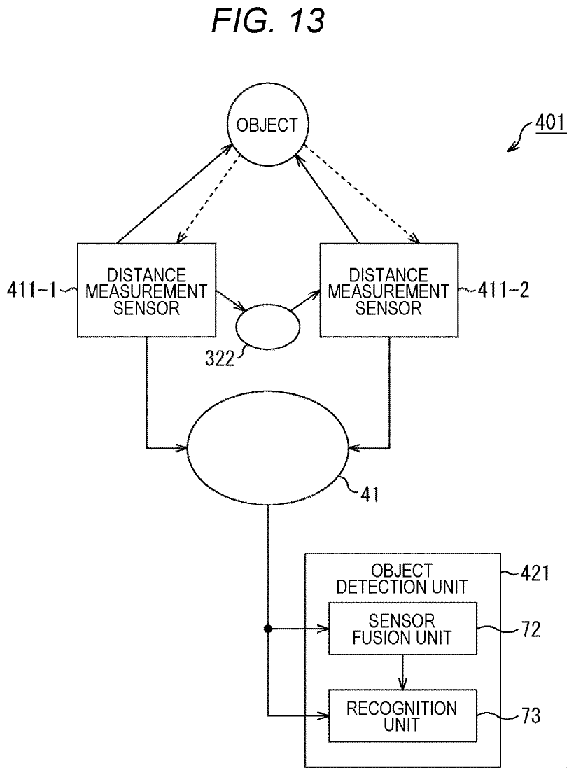

FIG. 13 is a block diagram illustrating a third configuration example of an object detection system to which the present technology is applied in the vehicle control system of FIG. 1.

An object detection system 401 in FIG. 13 includes a distance measurement sensor 411-1, a distance measurement sensor 411-2, the communication network 41, the network 322, and an object detection unit 421. Note that, in FIG. 13, portions corresponding to those in FIGS. 3 and 11 are denoted by corresponding reference signs, and the description thereof is repeated, and thus, will be omitted.

The distance measurement sensor 411-1 and the distance measurement sensor 411-2 are different types of distance measurement sensors, and include any of the radar 52, the LiDAR 53, the camera 51, the ultrasonic sensor 54, and the like.

The distance measurement sensor 411-1 is basically configured similarly to the radar 311-1 of FIG. 11. The distance measurement sensor 411-1 generates an extracted radar signal obtained by extracting a part of a radar signal on the basis of a spectrum of a specific component of a digital radar signal obtained as a reflected wave from an object. At that time, the distance measurement sensor 411-1 sets a region of interest on the basis of a distance-velocity spectrum obtained from the digital radar signal, and transmits region-of-interest information to the distance measurement sensor 411-2 via the network 322. Furthermore, the distance measurement sensor 411-1 generates an extracted radar signal on the basis of the set region of interest, and transmits the extracted radar signal as first sensor data to the object detection unit 421.

The distance measurement sensor 411-2 is basically configured similarly to the radar 311-2 of FIG. 11. The distance measurement sensor 411-2 generates an extracted radar signal obtained by extracting a part of a radar signal on the basis of a spectrum of a specific component of a digital radar signal obtained as a reflected wave from the object. At that time, the distance measurement sensor 411-2 generates the extracted radar signal on the basis of the region of interest indicated by the region-of-interest information received via the network 322, and transmits the extracted radar signal as second sensor data to the object detection unit 421.

Specifically, for example, in a case where the distance measurement sensor 411-1 is the LiDAR 53 and the distance measurement sensor 411-2 is the radar 52, the radar 52 can extract a component included in a region of interest from a distance-velocity spectrum on the basis of region-of-interest information set on the basis of a distance spectrum of the LiDAR 53.

The object detection unit 421 includes the sensor fusion unit 72 and the recognition unit 73.

The sensor fusion unit 72 performs sensor fusion processing of combining a plurality of different types of the sensor data transmitted from the distance measurement sensor 411-1 and the distance measurement sensor 411-2 to obtain new information. The combined sensor data is output to the recognition unit 73.

The recognition unit 73 performs object detection processing using the sensor data combined by the sensor fusion unit 72.

As described above, it is also possible to share the region-of-interest information among the different types of distance measurement sensors.

### 5. Fourth Embodiment (Region Setting Based on Another Sensor Data)

<Fourth Configuration of Object Detection System>

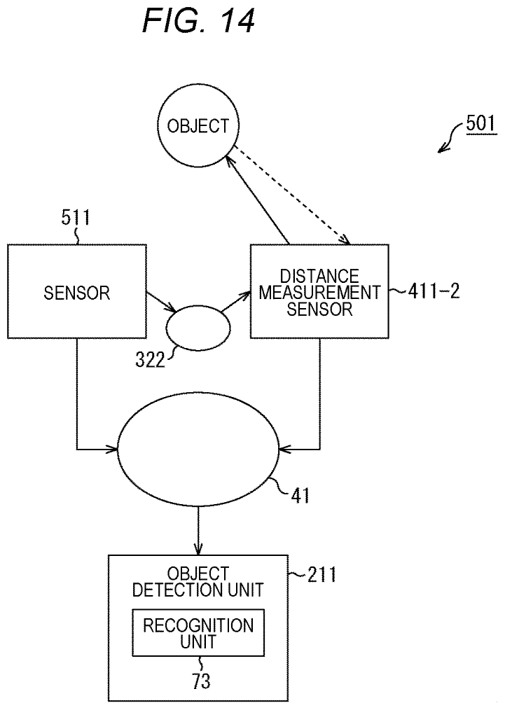

FIG. 14 is a block diagram illustrating a fourth configuration example of an object detection system to which the present technology is applied in the vehicle control system of FIG. 1.

An object detection system 501 in FIG. 14 includes a sensor 511, the distance measurement sensor 411-2, the communication network 41, the network 322, and an object detection unit 221. Note that, in FIG. 14, portions corresponding to those in FIGS. 3, 11, and 13 are denoted by corresponding reference signs, and the description thereof will be omitted.

The sensor 511 includes any of the camera 51, the radar 52, the LiDAR 53, the ultrasonic sensor 54, the gyro sensor, and the like in FIG. 1.

For example, the sensor 511 performs recognition processing of a surrounding environment. The sensor 511 sets a region that needs to be intensively monitored as a region of interest on the basis of an obtained result of the recognition processing. The sensor 511 transmits sensor data including region-of-interest information indicating the region of interest to the distance measurement sensor 411-2 via the network 322.

That is, the sensor 511 does not transmit the sensor data to the object detection unit 221, but transmits the sensor data including the information regarding the region of interest obtained as the result of the recognition processing by the sensor 511 to the distance measurement sensor 411-2, which is different from the distance measurement sensor 411-1 in FIG. 13.

When generating an extracted radar signal, the distance measurement sensor 411-2 generates the extracted radar signal on the basis of the region of interest indicated by the region-of-interest information received via the network 322, and transmits the extracted radar signal as sensor data to the object detection unit 211.

As described above, the region of interest may be set using sensor data, information, image data, and the like for recognizing the surrounding environment which are obtained by another sensor, a camera, and the like, and the set region of interest may be used in the distance measurement sensor.

### 6. Fifth Embodiment (Transmission of Difference Signal)

<Configuration Example of Signal Extraction Unit>

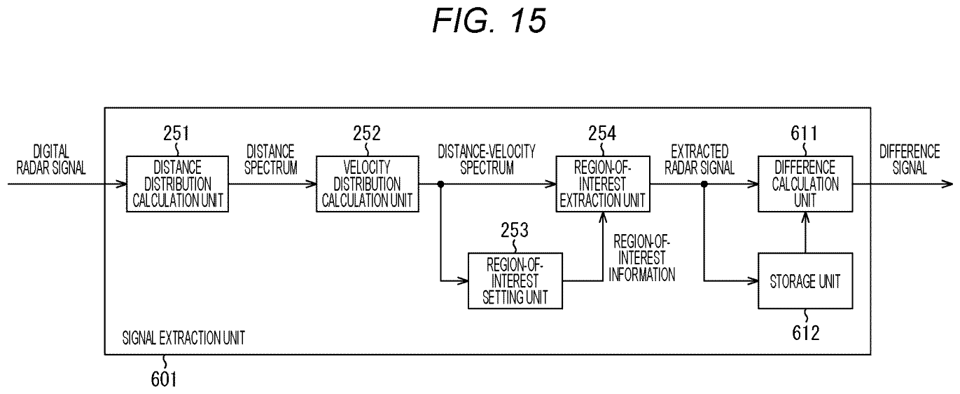

Note that difference data between newly acquired sensor data and held sensor data may be transmitted to the object detection unit 211. In this case, a signal extraction unit is configured as illustrated in FIG. 15.

FIG. 15 is a block diagram illustrating another configuration example of the signal extraction unit.

Note that, in FIG. 15, portions corresponding to those in FIG. 6 are denoted by corresponding reference signs, and the description thereof is repeated, and thus, will be omitted

A signal extraction unit 601 in FIG. 15 includes the distance distribution calculation unit 251, the velocity distribution calculation unit 252, the region-of-interest setting unit 253, the region-of-interest extraction unit 254, a difference calculation unit 611, and a storage unit 612.

The region-of-interest extraction unit 254 outputs a generated extracted radar signal to the difference calculation unit 611 and the storage unit 612.

The difference calculation unit 611 calculates a difference signal between the extracted radar signal supplied from the region-of-interest extraction unit 254 and an extracted radar signal held in the storage unit 612, and transmits the difference signal as sensor data to the object detection unit 211.

The storage unit 612 holds the extracted radar signal supplied from the region-of-interest extraction unit 254.

Note that the difference signal may be generated from a one-dimensional spectrum such as a distance spectrum, a velocity spectrum, or an angle spectrum, may be generated from a two-dimensional spectrum such as a distance-velocity spectrum, a velocity-angle spectrum, or an angle-distance spectrum, or may be generated from a three-dimensional spectrum such as a distance-velocity-angle spectrum.

When the difference signal is transmitted as the sensor data as described above, the amount of data can be reduced particularly in a situation where there is little change in a surrounding environment.

### 7. Others

<Effects>

As described above, in the present technology, a part of sensor data of a distance measurement sensor is extracted to generate extracted data on the basis of a spectrum of a specific component of the sensor data.

Therefore, only the extracted data can be transmitted, and thus, a capacity of a transmission path required for transmission of the sensor data and a required transmission rate, that is, a required processing capability of the transmission path can be lowered.

Furthermore, since data other than the part of the sensor data is deleted, it is possible to reduce the data amount of the sensor data while suppressing the influence on object detection processing.

<Program>

The above-described series of processes can be executed not only by hardware but also by software. In a case where the series of processes is executed by software, a program constituting the software is installed from a program recording medium to a computer incorporated in dedicated hardware, a general-purpose personal computer, or the like.

In the computer configured as described above, the vehicle control ECU 21 loads, for example, the program stored in the recording unit 28 into the RAM constituting the recording unit 28 via the communication network 41 and executes the program as illustrated in FIG. 1, whereby the above-described series of processes is performed.

The program executed by the vehicle control ECU 21 is provided in the state of being recorded in, for example, a removable medium or provided via a wired or wireless transmission medium such as a local area network, the Internet, or digital broadcasting, and is installed in the recording unit 28.

The program executed by the computer may be a program in which the processes are performed in a time-series order according to the order described in the present specification or may be a program in which the processes are performed in parallel or at necessary timing such as when a call is made.

Note that a system in the present specification means a set of a plurality of constituent elements (devices, modules (components), and the like), and whether or not all the constituent elements are provided in the same housing does not matter. Therefore, both a plurality of devices housed in separate housings and connected via a network, and one device in which a plurality of modules is housed in one housing are systems.

Furthermore, the effects described in the present specification are merely examples and are not limited, and there may be other effects.

Embodiments of the present technology are not limited to the above-described embodiments, and various modifications can be made within a scope not departing from a gist of the present technology.

For example, the present technology can adopt a cloud computing configuration in which one function is shared and processed by a plurality of devices via a network.

Furthermore, each step described in the above-described flowcharts can be not only executed by one device but also shared and executed by a plurality of devices.

Moreover, in a case where a plurality of processes is included in one step, the plurality of processes included in one step can be not only executed by one device but also shared and executed by a plurality of devices.

<Combination Example of Configurations>

The present technology can also have the following configurations.

(1)

An information processing device including
a signal extraction unit that extracts a part of sensor data of a distance measurement sensor to generate extracted data on the basis of a spectrum of a specific component of the sensor data.

(2)

The information processing device according to (1), further including
a region-of-interest setting unit that sets a first region of interest of the spectrum of the sensor data, in which
the signal extraction unit generates the extracted data on the basis of the first region of interest.

(3)

The information processing device according to (2), in which
the region-of-interest setting unit sets the first region of interest on the basis of an intensity of the spectrum of the sensor data.

(4)

The information processing device according to (3), in which
the region-of-interest setting unit sets a region in which the intensity of the spectrum of the sensor data is equal to or more than a predetermined threshold as the first region of interest.

(5)

The information processing device according to (2), in which
the region-of-interest setting unit sets the first region of interest on the basis of a second region of interest set by a distance measurement sensor of a different type from the distance measurement sensor.

(6)

The information processing device according to (2), in which
the region-of-interest setting unit sets the first region of interest on the basis of a second region of interest set by another sensor data.

(7)

The information processing device according to (2), in which
the signal extraction unit extracts a component included in the first region of interest of the spectrum of the sensor data to generate the extracted data.

(8)

The information processing device according to any one of (1) to (7), in which
the specific component includes at least one of a distance, a velocity, or an angle.

(9)

The information processing device according to (8), in which
the specific component includes a distance and a velocity.

(10)

The information processing device according to (1), further including
a converter that converts the sensor data into a one-dimensional spectrum and converts the one-dimensional spectrum into a two-dimensional spectrum, in which
the signal extraction unit extracts a part of components of the two-dimensional spectrum of the sensor data to generate the extracted data.

(11)

The information processing device according to any one of (1) to (10), further including:
a storage unit that holds the extracted data; and
a calculation unit that calculates difference data between the extracted data and temporally previous extracted data held in the storage unit.

(12)

The information processing device according to any one of (1) to (11), in which the distance measurement sensor is a millimeter wave radar.

(13)

The information processing device according to any one of (1) to (11), in which the distance measurement sensor is LiDAR.

(14)

An information processing method including
extracting, by an information processing device, a part of sensor data of a distance measurement sensor to generate extracted data on the basis of a spectrum of a specific component of the sensor data.

(15)

An information processing system including:
a distance measurement sensor that extracts a part of sensor data to generate extracted data on the basis of a spectrum of a specific component of the sensor data; and
a network that transmits the extracted data output from the distance measurement sensor.

(16)

The information processing system according to (15), further including
an object detection unit that receives the extracted data transmitted via the network and detects an object on the basis of the extracted data.

(17)

The information processing system according to (15) or (16), in which
the distance measurement sensor further includes a storage unit that holds the extracted data, and
difference data between the extracted data and temporally previous extracted data held in the storage unit is calculated, and the network transmits the difference data.

(18)

The information processing system according to any one of (15) to (17), in which
the distance measurement sensor includes two or more sensors.

(19)

The information processing system according to any one of (15) to (18), in which
the distance measurement sensor includes at least two or more types of distance measurement sensors.

### REFERENCE SIGNS LIST

1 Vehicle
11 Vehicle control system
21 Vehicle control ECU
25 External recognition sensor
41 Communication network
51 Camera
52, 52-1, 52-2 Radar
53 LiDAR
54 Ultrasonic sensor
28 Storage unit
61 Analysis unit
71 Accident location estimation unit
72 Sensor fusion unit
73 Recognition unit
201 Object detection system
211 Object detection unit
231 Wireless signal transmitter
232 Wireless signal receiver
233 Demodulator
234 A/D converter
235 Signal extraction unit
301 Object detection system
311-1, 311-2, 311 Radar
321-1, 321-2 Signal extraction unit
322 Network
331-1, 331-2 Region-of-interest setting unit
401 Object detection system
411-1, 411-2 Distance measurement sensor
421 Object detection unit
501 Object detection system
511 Sensor
601 Signal extraction unit
611 Difference calculation unit
612 Storage unit

1. An information processing device comprising
a signal extraction unit that extracts a part of sensor data of a distance measurement sensor to generate extracted data on a basis of a spectrum of a specific component of the sensor data.

2. The information processing device according to claim 1, further comprising
a region-of-interest setting unit that sets a first region of interest of the spectrum of the sensor data, wherein
the signal extraction unit generates the extracted data on a basis of the first region of interest.

3. The information processing device according to claim 2, wherein
the region-of-interest setting unit sets the first region of interest on a basis of an intensity of the spectrum of the sensor data.

4. The information processing device according to claim 3, wherein
the region-of-interest setting unit sets a region in which the intensity of the spectrum of the sensor data is equal to or more than a predetermined threshold as the first region of interest.

5. The information processing device according to claim 2, wherein
the region-of-interest setting unit sets the first region of interest on a basis of a second region of interest set by a distance measurement sensor of a different type from the distance measurement sensor.

6. The information processing device according to claim 2, wherein
the region-of-interest setting unit sets the first region of interest on a basis of a second region of interest set by another sensor data.

7. The information processing device according to claim 2, wherein
the signal extraction unit extracts a component included in the first region of interest of the spectrum of the sensor data to generate the extracted data.

8. The information processing device according to claim 1, wherein
the specific component includes at least one of a distance, a velocity, or an angle.

9. The information processing device according to claim 8, wherein
the specific component includes a distance and a velocity.

10. The information processing device according to claim 1, further comprising
a converter that converts the sensor data into a one-dimensional spectrum and converts the one-dimensional spectrum into a two-dimensional spectrum, wherein
the signal extraction unit extracts a part of components of the two-dimensional spectrum of the sensor data to generate the extracted data.

11. The information processing device according to claim 1, further comprising:
a storage unit that holds the extracted data; and
a calculation unit that calculates difference data between the extracted data and temporally previous extracted data held in the storage unit.

12. The information processing device according to claim 1, wherein
the distance measurement sensor is a millimeter wave radar.

13. The information processing device according to claim 1, wherein
the distance measurement sensor is LiDAR.

14. An information processing method comprising
extracting, by an information processing device, a part of sensor data of a distance measurement sensor to generate extracted data on a basis of a spectrum of a specific component of the sensor data.

15. An information processing system comprising:
a distance measurement sensor that extracts a part of sensor data to generate extracted data on a basis of a spectrum of a specific component of the sensor data; and
a network that transmits the extracted data output from the distance measurement sensor.

16. The information processing system according to claim further comprising
an object detection unit that receives the extracted data transmitted via the network and detects an object on a basis of the extracted data.

17. The information processing system according to claim wherein
the distance measurement sensor further includes a storage unit that holds the extracted data, and
difference data between the extracted data and temporally previous extracted data held in the storage unit is calculated, and the network transmits the difference data.

18. The information processing system according to claim wherein
the distance measurement sensor includes two or more sensors.

19. The information processing system according to claim 18, wherein
the distance measurement sensor includes at least two or more types of distance measurement sensors.
